(19) United States
(12) Patent Application Publication
(10) Pub. No.: US 2026/0082459 A1
(43) Pub. Date: Mar. 19, 2026

(54) METHODS FOR OPERATING A COOKING APPLIANCE

(71) Applicant: Haier US Appliance Solutions, Inc., Wilmington, DE (US)

(72) Inventor: Bagawathkumar Chellappan, Prospect, KY (US)

(21) Appl. No.: 18/889,986

(22) Filed: Sep. 19, 2024

(51) Int. Cl. H05B 6/64; G01F 23/2962

(52) U.S. Cl. CPC H05B 6/6467; G01F 23/2962; H05B 6/645

(57) ABSTRACT

A cooking appliance includes a cabinet and a cooking chamber defined within the cabinet. A method for operating the cooking appliance includes receiving, with a controller, sensor data from a sensor. The sensor data is indicative of fluid within a food container configured for heating by the cooking appliance. Additionally, the method includes determining, with the controller, whether the indicated fluid within the food container is outside of a selected fluid level range. Furthermore, the method includes operating, with the controller, the cooking appliance based on determining whether the indicated fluid within the food container is outside of the selected fluid level range.

### FIELD OF THE INVENTION

The present subject matter relates generally to cooking appliances, and more particularly to methods for operating cooking appliances.

### BACKGROUND OF THE INVENTION

Cooking appliances, such as microwave appliances, may be used by consumers to perform tasks such as heating or cooking food. Generally, microwave appliances include a cabinet that defines a cooking chamber for receipt of food items for cooking. In order to provide selective access to the cooking chamber and to contain food items and cooking energy (e.g., microwaves) during a cooking operation, a door is further included that is typically pivotally mounted to the cabinet. During use, a magnetron may generate microwave radiation or microwaves that are directed specifically to the cooking chamber. The microwave radiation is typically able to heat and cook food items within the cooking chamber faster than would be possible with conventional cooking methods using direct or indirect heating methods. Moreover, since microwave appliances are often smaller than other appliances (e.g., a conventional baking oven) within a kitchen, microwave appliances are often preferable for heating relatively small portions or amounts of food.

Sometimes, cooking or heating with cooking appliances includes cooking or heating fluid in a container. However, oftentimes the fluid level within the container is not adequate for desired or selected cooking outcomes or to protect components from the temperature within the cooking appliance and/or the microwaves emitted within the cooking appliance.

Accordingly, methods for operating a cooking appliance would be desirable. More specifically, a methods for operating a cooking appliance based on the fluid level within a food container for heating by the cooking appliance would be particularly beneficial.

### BRIEF DESCRIPTION OF THE INVENTION

Aspects and advantages of the invention will be set forth in part in the following description, or may be obvious from the description, or may be learned through practice of the invention.

In one example aspect of the present disclosure, a method of operating a cooking appliance is provided. The cooking appliance includes a cabinet and a cooking chamber defined within the cabinet. The method includes receiving, with a controller, first sensor data from a first sensor. The first sensor data is indicative of a fluid level of fluid within a food container relative to a second sensor at least partially submerged in the fluid. The food container is configured for heating by the cooking appliance. Additionally, the method includes measuring, with the controller, the fluid level within the food container relative to the second sensor based on the received first sensor data. Furthermore, the method includes determining, with the controller, whether the measured fluid level within the food container relative to the second sensor is outside of a selected fluid level range. Moreover, the method includes operating, with the controller, the cooking appliance based on determining whether the measured fluid level within the food container relative to the second sensor is outside of the selected fluid level range.

In another example aspect of the present disclosure, a method of operating a cooking appliance is provided. The cooking appliance includes a cabinet and a cooking chamber defined within the cabinet. The method includes receiving, with a controller, sensor data from a sensor. The sensor data is indicative of fluid within a food container. The food container is configured for heating by the cooking appliance. Additionally, the method includes determining, with the controller, whether the indicated fluid within the food container is outside of a selected fluid level range. Furthermore, the method includes operating, with the controller, the cooking appliance based on determining whether the indicated fluid within the food container is outside of the selected fluid level range.

These and other features, aspects and advantages of the present invention will become better understood with reference to the following description and appended claims. The accompanying drawings, which are incorporated in and constitute a part of this specification, illustrate embodiments of the invention and, together with the description, serve to explain the principles of the invention.

### BRIEF DESCRIPTION OF THE DRAWINGS

A full and enabling disclosure of the present invention, including the best mode thereof, directed to one of ordinary skill in the art, is set forth in the specification, which makes reference to the appended figures.

FIG. 1 provides a perspective view of a cooking appliance according to exemplary embodiments of the present disclosure.

FIG. 2 provides a perspective view of the exemplary cooking appliance of FIG. 1, wherein the door is an open position.

FIG. 3 provides a sectional view of the exemplary cooking appliance of FIG. 2.

FIG. 4 provides a sectional view of an exemplary measuring device to be utilized with a cooking appliance according to exemplary embodiments of the present disclosure.

FIG. 5 provides a sectional view of a cooking container with the exemplary measuring device of FIG. 4 positioned within the cooking container.

FIG. 6 provides a flowchart of an example method of operating a cooking appliance according to example embodiments of the present disclosure.

FIG. 7 provides a flowchart of another example method of operating a cooking appliance according to example embodiments of the present disclosure.

Repeat use of reference characters in the present specification and drawings is intended to represent the same or analogous features or elements of the present invention.

### DETAILED DESCRIPTION OF THE INVENTION

Reference now will be made in detail to embodiments of the invention, one or more examples of which are illustrated in the drawings. The word “exemplary” is used herein to mean “serving as an example, instance, or illustration.” In addition, references to “an embodiment” or “one embodiment” does not necessarily refer to the same embodiment, although it may. Any implementation described herein as “exemplary” or “an embodiment” is not necessarily to be construed as preferred or advantageous over other implementations. Moreover, each example is provided by way of explanation of the invention, not limitation of the invention. In fact, it will be apparent to those skilled in the art that various modifications and variations can be made in the present invention without departing from the scope of the invention. For instance, features illustrated or described as part of one embodiment can be used with another embodiment to yield a still further embodiment. Thus, it is intended that the present invention covers such modifications and variations as come within the scope of the appended claims and their equivalents.

As used herein, the terms “first,” “second,” and “third” may be used interchangeably to distinguish one component from another and are not intended to signify location or importance of the individual components. The terms “includes” and “including” are intended to be inclusive in a manner similar to the term “comprising.” Similarly, the term “or” is generally intended to be inclusive (i.e., “A or B” is intended to mean “A or B or both”). The term “at least one of” in the context of, e.g., “at least one of A, B, and C” refers to only A, only B, only C, or any combination of A, B, and C. In addition, here and throughout the specification and claims, range limitations may be combined and/or interchanged. Such ranges are identified and include all the sub-ranges contained therein unless context or language indicates otherwise. For example, all ranges disclosed herein are inclusive of the endpoints, and the endpoints are independently combinable with each other. The singular forms “a,” “an,” and “the” include plural references unless the context clearly dictates otherwise.

Approximating language, as used herein throughout the specification and claims, may be applied to modify any quantitative representation that could permissibly vary without resulting in a change in the basic function to which it is related. Accordingly, a value modified by a term or terms, such as “generally,” “about,” “approximately,” and “substantially,” are not to be limited to the precise value specified. In at least some instances, the approximating language may correspond to the precision of an instrument for measuring the value, or the precision of the methods or machines for constructing or manufacturing the components and/or systems. For example, the approximating language may refer to being within a ten percent margin, i.e., including values within ten percent greater or less than the stated value. In this regard, for example, when used in the context of an angle or direction, such terms include within ten degrees greater or less than the stated angle or direction, e.g., “generally vertical” includes forming an angle of up to ten degrees in any direction, e.g., clockwise or counterclockwise, with the vertical direction V.

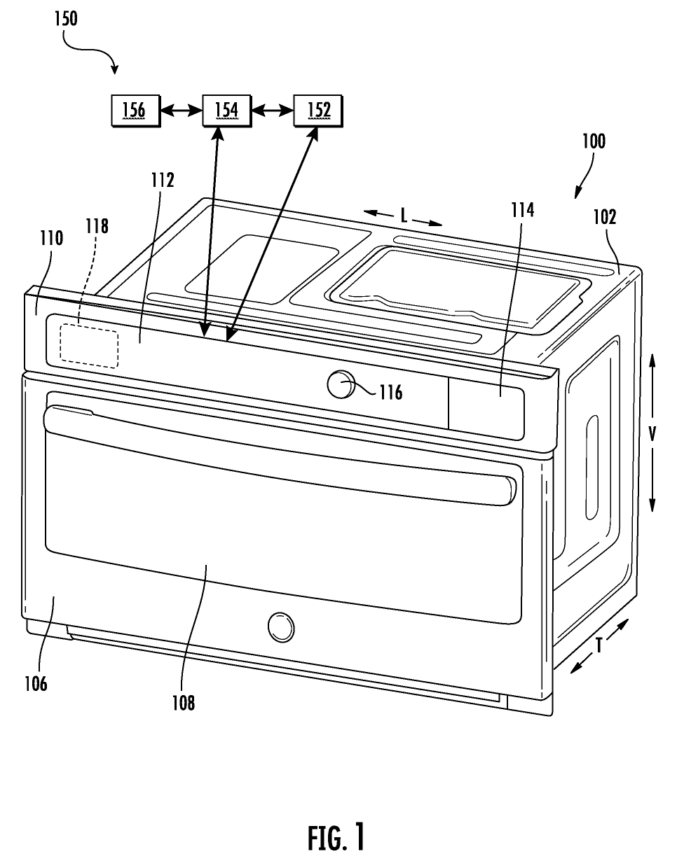

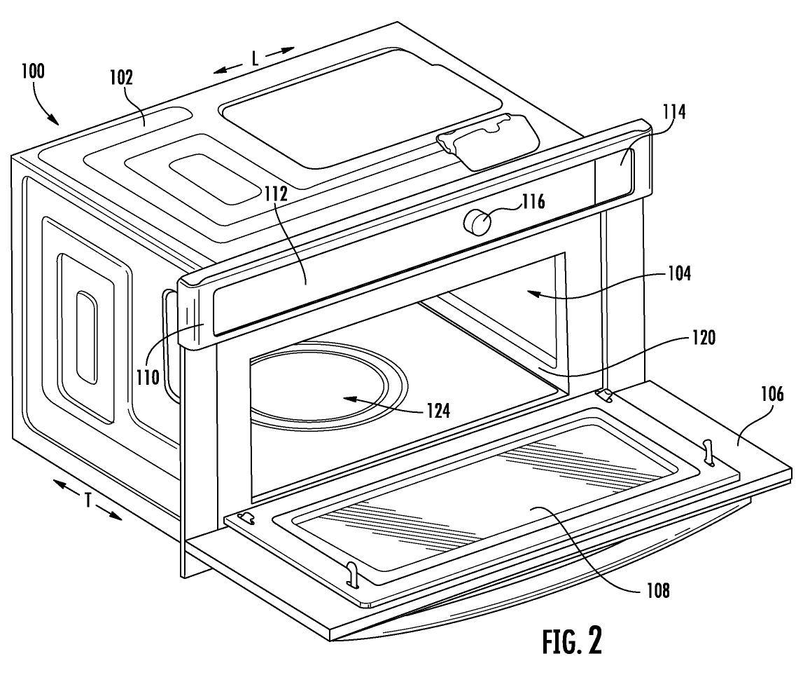

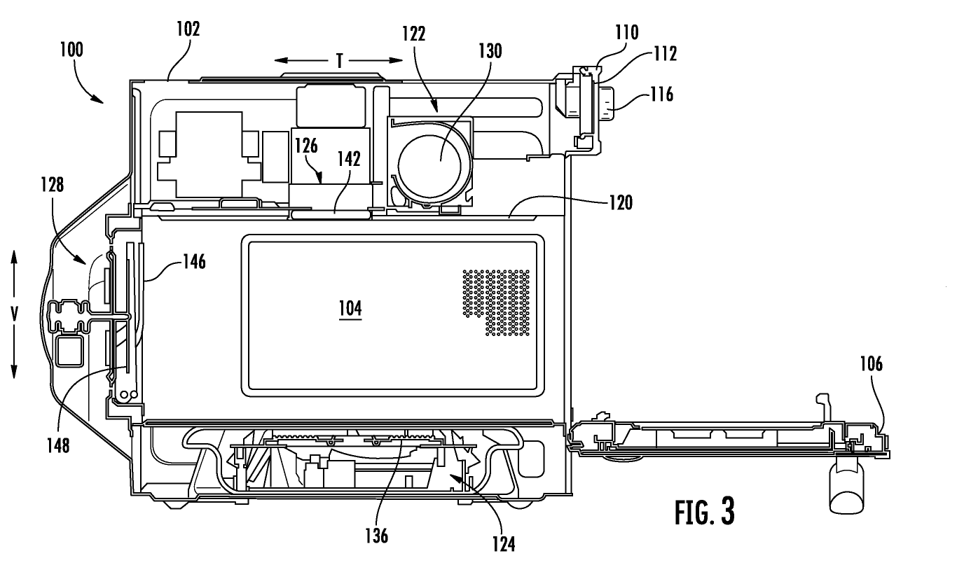

Referring to the figures, FIGS. 1 through 3 provide various views of a cooking appliance 100 according to exemplary embodiments of the present disclosure. Specifically, FIGS. 1 and 2 provide perspective views of cooking appliance 100 having a door 106 in an open position and a closed position, respectively. FIG. 3 provides a side, sectional view of cooking appliance 100, wherein door 106 is in the open position.

While described in the context of a specific embodiment of a microwave appliance, it should be appreciated that the cooking appliance 100 is provided by way of example only. It will be understood that aspects of the present subject matter may be used in any other suitable cooking appliance, such as a conventional oven or a convection oven, a toaster oven, an air fryer, and/or the like. Indeed, modifications and variations may be made to the cooking appliance 100, including different configurations, different appearances, and/or different features while remaining within the scope of the present subject matter.

Generally, cooking appliance 100 includes a housing or cabinet 102 that defines a mutually orthogonal vertical direction V, lateral direction L, and transverse direction T. Within cabinet 102, cooking appliance 100 defines a cooking chamber 104 in which food items may be received. In some embodiments, a door 106 is rotatably mounted to move between the open position and the closed position. As shown, the open position permits access to cooking chamber 104 while the closed position restricts access to cooking chamber 104. A window 108 in door 106 may be provided (e.g., for viewing food items in the cooking chamber 104). Additionally, or alternatively, a handle may be secured to door 106 (e.g., to rotate therewith). The handle may be formed of plastic, for example, and may be injection molded.

In certain embodiments, cooking appliance 100 includes a control panel frame 110 on or as part of cabinet 102. A control panel 112 may be mounted within control panel frame 110. Generally, control panel 112 includes a display device 114 for presenting various information to a user. For example, display device 114 may present various notifications to the user. Control panel 112 may also include one or more input devices (e.g., tactile buttons, knobs, touch screens, etc.) for selecting a desired mode of operation, such as a heating operation. Additionally, control panel 112 may also include one or more input devices for selecting various parameters associated with a mode of operation. For example, control panel 112 may include input devices for selecting a cooking time, a food content cooked temperature, and/or a cooking power level. In optional embodiments, the input devices of control panel 112 include a knob or dial 116. Selections may be made by rotating dial 116 clockwise or counterclockwise, and when the desired selection is displayed, pressing dial 116. For example, many meal cook cycles and other cooking algorithms may be preprogrammed in or loaded onto a memory device of a controller 118 of cooking appliance 100 for many different food item types (e.g., pizza, fried chicken, French fries, potatoes, etc.), including simultaneous preparation of a group of food items of different food types comprising an entire meal. Instructions or selections may be displayed on display device 114. In optional embodiments, display device 114 may be used as an input device. For instance, display device 114 may be a touchscreen device, as is understood.

In exemplary embodiments, cabinet 102 of cooking appliance 100 includes an inner shell 120. Inner shell 120 of cabinet 102 delineates the interior volume of cooking chamber 104. Optionally, the walls of shell may be constructed using high reflectivity (e.g., 72% reflectivity) stainless steel.

Cooking appliance 100 may include one or more cooking modules. In particular, cooking appliance 100 may include a microwave module 122. In some optional embodiments, cooking appliance 100 may include a lower heater module 124 mounted within cabinet 102. Additionally, or alternatively, in some optional embodiments, cooking appliance 100 may include an upper heater module 126 or a convection module 128.

Generally, microwave module 122 may include a magnetron 130 mounted within the cabinet 102 (e.g., above cooking chamber 104) and in communication (e.g., fluid or transmissive communication) with the cooking chamber 104 to emit or direct microwave radiation or microwaves thereto and/or within cooking chamber 104, such as during a heating operation of cooking appliance 100. In other words, the microwave module 122 delivers microwave radiation into cooking chamber 104.

Below microwave module 122, lower heater module 124 may be mounted within cabinet 102. For instance, lower heater module 124 may include a heating coil 136 mounted below cooking chamber 104. The heating coil 136 may be, e.g., an induction heating coil or a resistive heating coil. The heating coil 136 may be in communication (e.g., transmissive communication) with cooking chamber 104 for heating objects, e.g., food items and/or cooking utensils, positioned within the cooking chamber 104.

Upper heater module 126 may include one or more heating elements 142. For instance, upper heater module 126 may include one or more electric heating elements, such as a resistive heating element (e.g., sheathed resistive heater) or a radiant heating element (e.g., a halogen cooking lamp) in thermal communication with cooking chamber 104. Upper heater module 126 may be mounted within or above cooking chamber 104 or otherwise spaced apart from microwave module 122.

Convection module 128 may include a sheathed heater 146 and a convection fan 148. Convection fan 148 is provided for blowing or otherwise moving air over sheathed heater 146 of convection module 128 and into cooking chamber 104 (e.g., for convection cooking).

The specific heating elements of upper and lower heater modules 126 and 124, convection module 128, and magnetron 130 of microwave module 122 may vary from embodiment to embodiment, and the elements and system described above are exemplary only. For example, the upper heater module 126 or convection module 128 may include any combination of heaters including combinations of halogen lamps, ceramic lamps, or sheathed heaters.

As shown, cooking appliance 100 may include a controller 118. Controller 118 of cooking appliance 100 may include one or more processor(s) and one or more memory device(s). The processor(s) of controller 118 may be any suitable processing device, such as a microprocessor, microcontroller, integrated circuit, or other suitable processing device. The memory device(s) of controller 118 may include any suitable computing system or media, including, but not limited to, non-transitory computer-readable media, RAM, ROM, hard drives, flash drives, or other memory devices. The memory device(s) of controller 118 may store information accessible by the processor(s) of controller 118 including instructions that may be executed by the processor(s) of controller 118 in order to execute various cooking operations or cycles (e.g., a meal cook cycle). Controller 118 is communicatively coupled with various operational components of cooking appliance 100, such as components of microwave module 122, upper heater module 126, lower heater module 124, convection module 128, or control panel 112 (e.g., display device 114 or dial 116), the various control buttons, etc. Input/output (“I/O”) signals may be routed between controller 118 and control panel 112 as well as other operational components of cooking appliance 100. Controller 118 may execute and control cooking appliance 100 in various cooking operations or cycles, such as precision cooking, which includes meal cook, microwave, induction, or convection/bake modes.

Referring to FIG. 1, a schematic diagram of an external communication system 150 will be described according to an exemplary embodiment of the present subject matter. In general, external communication system 150 is configured for permitting interaction, data transfer, and other communications between cooking appliance 100 and one or more external devices. For example, this communication may be used to provide and receive operating parameters, user instructions or notifications, performance characteristics, user preferences, or any other suitable information for improved performance of cooking appliance 100. In addition, it should be appreciated that external communication system 150 may be used to transfer data or other information to improve performance of one or more external devices or appliances and/or improve user interaction with such devices.

For example, external communication system 150 permits controller 118 of cooking appliance 100 to communicate with a separate device external to cooking appliance 100, referred to generally herein as an external device 152. As described in more detail below, these communications may be facilitated using a wired or wireless connection, such as via a network 154. In general, external device 152 may be any suitable device separate from cooking appliance 100 that is configured to provide and/or receive communications, information, data, or commands from a user. In this regard, external device 152 may be, for example, a personal phone, a smartphone, a tablet, a laptop or personal computer, a wearable device, a smart home system, or another mobile or remote device.

In addition, a remote server 156 may be in communication with cooking appliance 100 and/or external device 152 through network 154. In this regard, for example, remote server 156 may be a cloud-based server 156, and is thus located at a distant location, such as in a separate state, country, etc. According to an exemplary embodiment, external device 152 may communicate with a remote server 156 over network 154, such as the Internet, to transmit/receive data or information, provide user inputs, receive user notifications or instructions, interact with or control cooking appliance 100, etc. In addition, external device 152 and remote server 156 may communicate with cooking appliance 100 to communicate similar information.

In general, communication between cooking appliance 100, external device 152, remote server 156, and/or other user devices or appliances may be carried using any type of wired or wireless connection and using any suitable type of communication network, non-limiting examples of which are provided below. For example, external device 152 may be in direct or indirect communication with cooking appliance 100 through any suitable wired or wireless communication connections or interfaces, such as network 154. For example, network 154 may include one or more of a local area network (LAN), a wide area network (WAN), a personal area network (PAN), the Internet, a cellular network, any other suitable short- or long-range wireless networks, etc. In addition, communications may be transmitted using any suitable communications devices or protocols, such as via Wi-Fi®, Bluetooth®, Zigbee®, wireless radio, laser, infrared, Ethernet type devices and interfaces, etc. In addition, such communication may use a variety of communication protocols (e.g., TCP/IP, HTTP, SMTP, FTP), encodings or formats (e.g., HTML, XML), and/or protection schemes (e.g., VPN, secure HTTP, SSL).

External communication system 150 is described herein according to an exemplary embodiment of the present subject matter. However, it should be appreciated that the exemplary functions and configurations of external communication system 150 provided herein are used only as examples to facilitate description of aspects of the present subject matter. System configurations may vary, other communication devices may be used to communicate directly or indirectly with one or more associated appliances, other communication protocols and steps may be implemented, etc. These variations and modifications are contemplated as within the scope of the present subject matter.

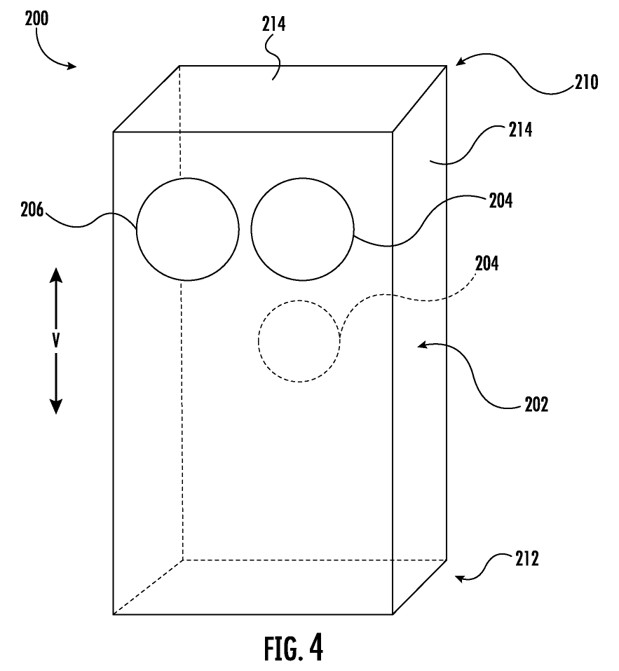

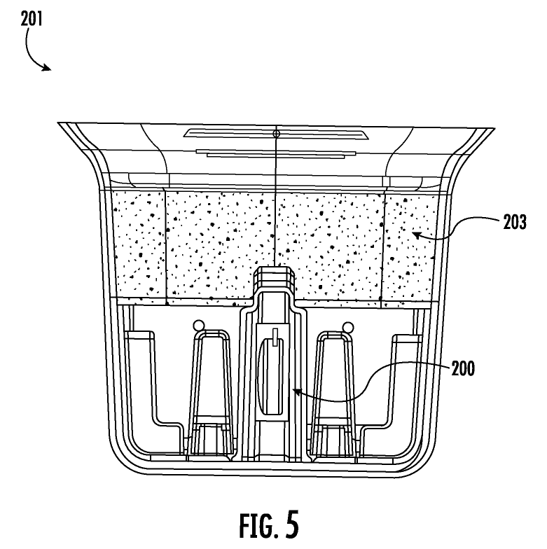

Referring now to FIGS. 4 and 5, various views of a measuring device 200 to be utilized with a cooking appliance are provided according to exemplary embodiments of the present disclosure. Specifically, FIG. 4 provides a sectional view of measuring device 200 and components therein. FIG. 5 provides a sectional view of a food container 201 and measuring device 200 positioned within food container 201.

The measuring device 200 may be configured as a stand-alone measuring device that may be utilized with cooking appliance 100 to measure one or more various parameters associated with cooking appliance 100. For example, measuring device 200 may be used to measure the temperature of food contents within food container 201 while food container 201 is positioned within cooking chamber 104 of cooking appliance 100. While described herein as being utilized with cooking appliance 100, it should be appreciated that measuring device 100 may be utilized with any other suitable cooking appliance, such as a conventional oven, convection oven, air fryer, and/or the like.

As illustrated in FIG. 4, measuring device 200 may include a housing 202 for housing various components of measuring device 200 within, such as electrical components. The housing 202 of measuring device 200 may generally extend between a top side 210 and a bottom side 212 in the vertical direction V, and one or more sidewalls 214 collectively defining a rectangularly-shaped perimeter of the housing 202. However, in other embodiments, sidewall(s) 214 may define any other polygonal-shaped perimeter of the housing 202, such as a cylindrical shape.

Additionally, measuring device 200 may include one or more sensors for measuring the various parameters associated with the operation of a cooking appliance, such as cooking appliance 100. For example, measuring device 200 may include a temperature sensor 204. As illustrated in FIG. 4, temperature sensor 204 may be positioned within housing 202. However, it should be appreciated that temperature sensor 204 may be positioned in any other suitable location, such as on housing 202 or otherwise externally of housing 202.

The temperature sensor 204 of measuring device 200 may be configured to generate data indicative of a temperature of food contents during a heating operation of cooking appliance 100, such as food contents within food container 201. The food contents may correspond to liquid-based food contents such as soup, coffee, tea, and/or the like, and/or solid food contents, such as steak, eggs, and/or the like, immersed and heated within a fluid, e.g., during a sous vide cooking process. In this respect, as illustrated in FIG. 5, measuring device 200 may be positioned within food container 201 so that the temperature of food contents within food container 201, such as a volume of water 203, may be measured. In some embodiments, measuring device 200 may be at least partially submerged in the liquid/fluid within food container 201 such that temperature sensor 204 is also submerged in the liquid/fluid within food container 201. In this respect, the temperature of the food contents within the food container 201 may be measured directly, such as by controller 118. As such, in optional embodiments, temperature sensor 204 may include a probe (not shown) insertable within the liquid/fluid within food container 201 so that the temperature of the food contents within the food container 201 may be measured directly.

Moreover, temperature sensor 204 may correspond to any suitable type of temperature sensor configured to generate data indicative of a temperature of food contents during a heating operation of a cooking appliance. For example, temperature sensor 204 may be configured as an infrared thermometer for contactless temperature measurements, a probe thermometer including a probe insertable within the food content for measuring temperature, and/or the like.

Furthermore, measuring device 200 may include a fluid sensor 206. As illustrated in FIG. 4, fluid sensor 206 may be positioned within housing 202. However, it should be appreciated that fluid sensor 206 may be positioned in any other suitable location, such as on housing 202 or otherwise externally of housing 202. Furthermore, while measuring device 200 is described herein as including both temperature sensor 204 and fluid sensor 206 within or on housing 202, it should be appreciated that temperature sensor 204 and fluid sensor 206 may be included in different/separate housings 202 or otherwise physically separated as separate devices. In this respect, for example, in some embodiments, fluid sensor 206 may be positioned on door 106 of cooking appliance 100, such as on door 106 such that fluid sensor 106 is positioned within cooking chamber 104 of cooking appliance 100 when door 106 is closed.

The fluid sensor 206 of measuring device 200 may be configured to generate data indicative of fluid within food container 201. As will be described below, the data generated by the fluid sensor 206 may be used by controller 118 of the cooking appliance 100 to detect the presence of fluid and/or to determine the fluid level, such as within food container 201. The fluid may correspond to fluid (e.g., water) within which solid food contents are cooked such as steak, eggs, and/or the like, immersed and heated within a fluid, e.g., during a sous vide cooking process and/or may correspond to liquid-based food contents such as soup, coffee, tea, and/or the like. As illustrated in FIG. 5, in some embodiments, measuring device 200 may be positioned within food container 201 externally of the fluid within food container 201 so that fluid sensor 206 is not positioned within the fluid within food container 201. However, in some other embodiments, measuring device 200 may be at least partially submerged in the liquid/fluid within food container 201 so that fluid sensor 206 is also submerged in the liquid/fluid within food container 201.

Additionally, fluid sensor 206 may correspond to any suitable type of fluid sensor configured to generate data indicative of the fluid within a food container. For example, in some exemplary embodiments, fluid sensor 206 may be configured as an ultrasonic sensor configured to emit sound waves, such as at food container 201, and analyze one or more parameters associated with reflected sound waves. The parameter(s) associated with reflected sound waves may correspond to a speed of the reflected sound waves, a time of flight to receive the reflected sound waves, and/or the like. However, it should be appreciated that fluid sensor 206 may correspond to any suitable fluid sensor configured to generate data indicative of the fluid within a food container, such as food container 201. For example, in some embodiments, the fluid sensor 206 may be configured as a pressure transducer configured to measure pressure of the fluid within fluid container 201, a float switch configured to move in response to submerging fluid sensor 206 into the fluid within food container 201, an optical sensor, e.g., laser, an imaging device, e.g., camera, and/or the like. Thereafter, as will be described below, controller 118 may utilize the data generated by fluid sensor 206, e.g., analyzed speed of the reflected sound waves, to determine whether the indicated fluid within food container 201 is outside of a selected fluid level range.

In general, temperature sensor 204 and fluid sensor 206 may be configured to connect wirelessly with/to controller 118 of cooking appliance 100. For example, temperature sensor 204 and/or fluid sensor 206 may wirelessly connect to controller 118 of cooking appliance 100 via external communication system 150. Additionally, temperature sensor 204 and fluid sensor 206 may be configured to connect wirelessly with/to a remote user device, such as a cell phone. For example, temperature sensor 204 and/or fluid sensor 206 may wirelessly connect to the remote user device via an external communication system separate from, but similar to external communication system 150 described above. The external communication system may be configured for permitting interaction, data transfer, and other communications between temperature sensor 204 and one or more external devices, such as the remote user device, and/or fluid sensor 206 and one or more external devices, such as the remote user device.

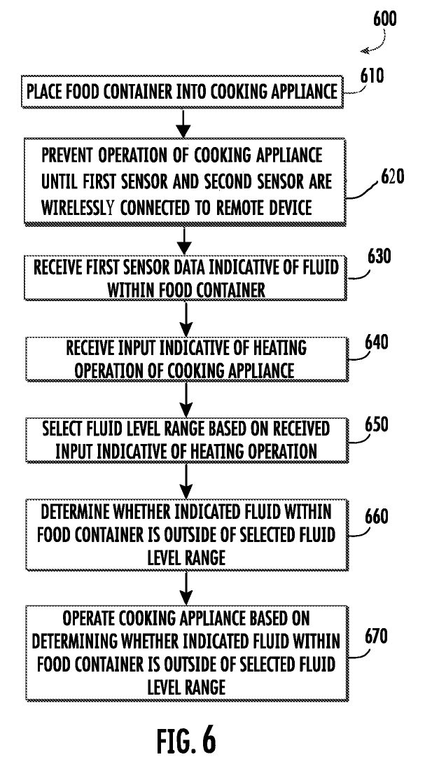

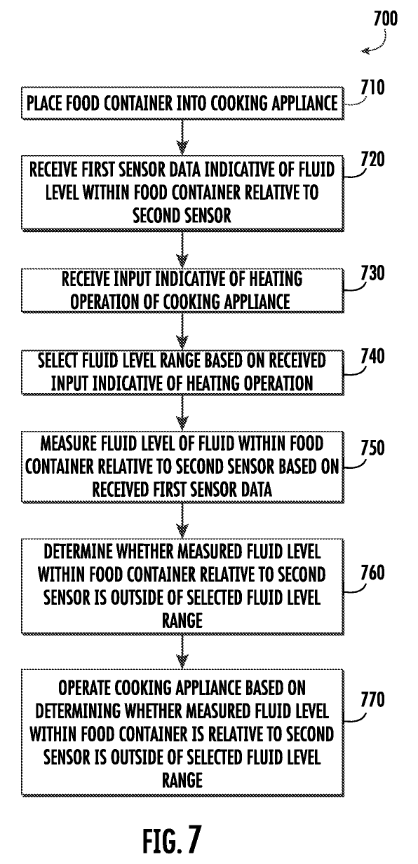

Referring now generally to FIGS. 6 and 7, the methods 600 and/or 700 may be interrelated and/or may have one or more steps from one of the methods 600 and 700 combined with the other method 600 or 700. Thus, those of ordinary skill in the art will recognize that the various steps of the exemplary methods described herein may be combined in various ways to arrive at additional embodiments within the scope of the present disclosure.

FIGS. 6 and 7 depict steps in a particular order for purpose of illustration and discussion. Those of ordinary skill in the art, using the disclosures provided herein, will understand that (except as otherwise indicated) methods 600 and 700 are not mutually exclusive. Moreover, the steps of the methods 600 and 700 can be modified, adapted, rearranged, omitted, interchanged, or expanded in various ways without deviating from the scope of the present disclosure.

Furthermore, the skilled artisan will recognize the interchangeability of various features from different embodiments. Similarly, the various method steps and features described, as well as other known equivalents for each such methods and feature, can be mixed and matched by one of ordinary skill in this art to construct additional systems and techniques in accordance with principles of this disclosure. Of course, it is to be understood that not necessarily all such objects or advantages described above may be achieved in accordance with any particular embodiment. Thus, for example, those skilled in the art will recognize that the systems and techniques described herein may be embodied or carried out in a manner that achieves or optimizes one advantage or group of advantages as taught herein without necessarily achieving other objects or advantages as may be taught or suggested herein.

Turning now to FIG. 6, an embodiment of the present disclosure may include a method of operating a cooking appliance, such as the exemplary cooking appliance 100 described above.

As shown in FIG. 6, method 600 may include placing a food container into a cooking appliance, e.g., as indicated at step 610 in FIG. 6. For example, for the cooking appliance 100 described above, food container 201 may be placed into cooking chamber 104 of cooking appliance 100 so that food contents within food container 201 may be cooked or heated by cooking appliance 100. In some optional embodiments, the method 600 may include a step 620 of preventing operation of the cooking appliance until a first sensor and a second sensor are wirelessly connected to a remote device. For example, controller 118 may prevent operation of cooking appliance 100, such as by preventing activation of magnetron 130, in response to controller 118 detecting that temperature sensor 204 and/or fluid sensor 206 are not wirelessly connecting to a remote device, such as a cell phone.

In some exemplary embodiments, after placing the food container into the cooking appliance, the method 600 may include a step 630 of receiving first sensor data indicative of fluid within the food container. The data may be generated by a first sensor, such as fluid sensor 206. Additionally, controller 118 may be operatively or communicatively coupled or connected to fluid sensor 206. As such, controller 118 may be configured to receive fluid sensor data from fluid sensor 206 indicative of the fluid within food container 201. For example, in some embodiments, fluid sensor 206 may be configured as the ultrasonic sensor described above. In this respect, controller 118 may be configured to receive the analyzed speed of reflected sound waves, which may be indicative of the fluid within food container 201.

Thereafter, in some optional embodiments, the method 600 may include receiving an input indicative of a heating operation of the cooking appliance, e.g., as indicated at step 640 in FIG. 6. Specifically, controller 118 may receive the input, such as a user/operator input from the input device(s) of control panel 112 of cooking appliance 100, indicative of the heating operation of cooking appliance 100. In some embodiments, the input may correspond to a cooking time indicative of a length of time for cooking appliance 100 to perform the heating operation. The cooking time may be selected by an operator of cooking appliance 100, such as via control panel 112, or may be selected by controller 118 based on the food content, such as the type of food content, within food container 201 as detected with one or more sensors and determined by controller 118. Additionally, or alternatively, in some other embodiments, the input may correspond to a user/operator selected temperature indicative of a temperature at which food contents within food container 201 will reach during the heating operation. Additionally, or alternatively, in some other embodiments, the input may correspond to a user/operator selected power level indicative of a power level at which cooking appliance 100 will operate during the heating operation. Additionally, or alternatively, in some other embodiments, the input may correspond to a user/operator input indicating whether a second sensor, such as temperature sensor 204 of measuring device 200, is present within cooking appliance 100.

Additionally, in some optional embodiments, the method 600 may include selecting a fluid level range, e.g., at step 650 in FIG. 6, based on the received input at step 640. Specifically, controller 118 may select the fluid level range of which the fluid indicated by the first sensor data received at step 630 will be compared based on the input received at step 640. The fluid level range selected by controller 118 may correspond to a desired fluid level range at which the fluid within fluid container 201 falls within during the heating operation based on the cooking time, the operator selected temperature, the operator selected power level, the operator input indicating whether the second sensor is present within cooking appliance 100, and/or the like.

Furthermore, in some exemplary embodiments, the method 600 may include determining whether the indicated fluid within the food container is outside of a selected fluid level range, e.g., at step 660 in FIG. 6. Specifically, controller 118 may be configured to determine that the indicated fluid within food container 201 is outside of the selected fluid level range and/or that the indicated fluid within the food container 201 is not outside of, or equal to/within, the selected fluid level range. The selected fluid level range may correspond to the fluid level range selected at optional step 640. However, it should be appreciated that the selected fluid level range may correspond to a fluid level range that is predetermined or preprogrammed and stored within the memory device(s) of controller 118. The indicated fluid within food container 201 being outside of the selected fluid level range may indicate that not enough, or any, fluid was placed into food container 201, that fluid loss has occurred, e.g., leaked from a crack within food container 201, and/or the like.

In some embodiments, determining whether the indicated fluid within the food container is outside of the selected fluid level range may include first detecting the presence of the fluid within the food container. Specifically, controller 118 may detect the presence, or lack thereof, of the fluid within food container 201. For example, when fluid sensor 206 is configured as the ultrasonic sensor, controller 118 may detect the presence, or lack thereof, of the fluid within food container 201 based on the analyzed speed of the reflected sound waves.

Additionally, or alternatively, in some embodiments, determining whether the indicated fluid within the food container is outside of the selected fluid level range may include measuring a fluid level of the fluid within the food container based on the received first sensor data and determining whether the measured fluid level within the food container is outside of the selected fluid level range. Specifically, controller 118 may measure the fluid level of the fluid within food container 201 based on the received data from fluid sensor 206. For example, when fluid sensor 206 is configured as the ultrasonic sensor, controller 118 may measure the fluid level within food container 201 based on the analyzed speed of the reflected sound waves. Thereafter, controller 118 may determine whether the measured fluid level within food container 201 is outside of the selected fluid level range. For example, in some embodiments, controller 118 may determine that the measured fluid level within food container 201 is outside of the selected fluid level range when the measured fluid level falls below and/or exceeds the selected fluid level range.

Moreover, in some exemplary embodiments, method 600 may include operating the cooking appliance based on determining whether the indicated fluid within the food container is outside of the selected fluid level range, e.g., at step 670 in FIG. 6. Specifically, controller 118 may operate cooking appliance 100 based on determining whether the indicated fluid within food container 201 is outside of the selected fluid level range. For example, controller 118 may be operatively or communicatively coupled to magnetron 130 of cooking appliance 100. In this respect, in some embodiments, controller 118 may deactivate magnetron 130 to prevent emission of microwaves within cooking chamber 104 of cooking appliance 100, such as in response to controller 118 detecting the lack of fluid within fluid container 201 and/or determining that the measured fluid level within fluid container 201 is outside of the selected fluid level range. Additionally, or alternatively, in some embodiments, controller 118 may operate magnetron 130 to adjust (e.g., decrease) the temperature within cooking chamber 104 of cooking appliance 100, such as in response to controller 118 detecting the lack of fluid within fluid container 201 and/or determining that the measured fluid level within fluid container 201 is outside of the selected fluid level range. Additionally, or alternatively, in some embodiments, controller 118 may provide an operator notification, such as on display device 114, to add fluid to food container 201, such as in response to controller 118 detecting the lack of fluid within fluid container 201 and/or determining that the measured fluid level within fluid container 201 is outside of the selected fluid level range.

Another exemplary method of operating a cooking appliance according to one or more embodiments of the present disclosure is illustrated in FIG. 7. As shown in FIG. 7, the exemplary method 700 may include a step 710 of placing a food container into a cooking appliance, e.g., as described above with respect to step 610 of method 600. Additionally, the method 700 may include receiving first sensor data from a first sensor indicative of a fluid level within the food container relative to a second sensor, e.g., at step 720 in FIG. 7. The data may be generated by a first sensor, such as fluid sensor 206. As such, controller 118 may be configured to receive fluid sensor data from fluid sensor 206 indicative of the fluid within food container 201 relative to a second sensor, such as temperature sensor 204. For example, in some embodiments, fluid sensor 206 may be configured as the ultrasonic sensor described above. In this respect, controller 118 may be configured to receive the analyzed speed of reflected sound waves, which may be indicative of the fluid level within food container 201 relative to temperature sensor 204.

Thereafter, as shown in FIG. 7, in some optional embodiments, step 730 of method 700 may include receiving an input indicative of a heating operation of the cooking appliance, e.g., as described above with respect to step 640 of method 600. Furthermore, as shown in FIG. 7, in some optional embodiments, step 740 of method 700 may include selecting a fluid level range based on the received input at step 730, e.g., as described above with respect to step 650 of method 600.

Moreover, in some exemplary embodiments, the method 700 may include measuring a fluid level of the fluid within the food container relative to the second sensor based on the received first sensor data, e.g., at step 750 in FIG. 7. Specifically, controller 118 may measure the fluid level of the fluid within food container 201 relative to temperature sensor 204, such as measuring how much of temperature sensor 204 is submerged within the fluid, based on the received data from fluid sensor 206. For example, when fluid sensor 206 is configured as the ultrasonic sensor, controller 118 may measure the fluid level within food container 201 relative to temperature sensor 204 based on the analyzed speed of the reflected sound waves.

Furthermore, in some exemplary embodiments, the method 700 may include determining whether the measured fluid level within the food container relative to the second sensor is outside of the selected fluid level range, e.g., at step 760 in FIG. 7. Specifically, controller 118 may determine whether the measured fluid level within food container 201 relative to temperature sensor 204 is outside of the selected fluid level range. For example, in some embodiments, controller 118 may determine that the measured fluid level within food container 201 relative to temperature sensor 204 is outside of the selected fluid level range when the measured fluid level relative to temperature sensor 204 falls below and/or exceeds the selected fluid level range. The measured fluid level within food container 201 being outside of the selected fluid level range may indicate that not enough, or any, fluid was placed into food container 201, that fluid loss has occurred, e.g., leaked from a crack within food container 201, and/or the like.

Additionally, in some exemplary embodiments, method 700 may include operating the cooking appliance based on determining whether the measured fluid level within the food container relative to the second sensor is outside of the selected fluid level range, e.g., at step 770 in FIG. 7. Specifically, controller 118 may operate cooking appliance 100 based on determining whether the fluid level within food container 201 relative to temperature sensor 204 measured at step 760 is outside of the selected fluid level range. For example, in some embodiments, controller 118 may deactivate magnetron 130 to prevent emission of microwaves within cooking chamber 104 of cooking appliance 100, such as in response to controller 118 determining that the measured fluid level within fluid container 201 relative to temperature sensor 204 is outside of the selected fluid level range. Additionally, or alternatively, in some embodiments, controller 118 may operate magnetron 130 to adjust (e.g., decrease) the temperature within cooking chamber 104 of cooking appliance 100, such as in response to controller 118 detecting the lack of fluid within fluid container 201 and/or determining that the measured fluid level within fluid container 201 is outside of the selected fluid level range. Additionally, or alternatively, in some embodiments, controller 118 may provide an operator notification, such as on display device 114, to add fluid to food container 201, such as in response to controller 118 determining that the measured fluid level within fluid container 201 relative to temperature sensor 204 is outside of the selected fluid level range. Additionally, or alternatively, in some other embodiments, controller 118 may provide an operator notification, such as on display device 114, to adjust a position of temperature sensor 204 relative to the fluid within food container 201 when determined that the measured fluid level within food container 201 relative to temperature sensor 204 is outside of the selected fluid level range.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they include structural elements that do not differ from the literal language of the claims, or if they include equivalent structural elements with insubstantial differences from the literal languages of the claims.

What is claimed is:

1. A method of operating a cooking appliance, the cooking appliance comprising a cabinet and a cooking chamber defined within the cabinet, the method comprising:
receiving, with a controller, first sensor data from a first sensor, the first sensor data indicative of a fluid level of fluid within a food container relative to a second sensor at least partially submerged in the fluid, the food container configured for heating by the cooking appliance;
measuring, with the controller, the fluid level within the food container relative to the second sensor based on the received first sensor data;
determining, with the controller, whether the measured fluid level within the food container relative to the second sensor is outside of a selected fluid level range; and
operating, with the controller, the cooking appliance based on determining whether the measured fluid level within the food container relative to the second sensor is outside of the selected fluid level range.

2. The method of claim 1, wherein:
the first sensor is configured as an ultrasonic sensor configured to emit sound waves into the food container and analyze a speed of reflected sound waves; and
measuring the fluid level comprises measuring, with the controller, the fluid level within the food container relative to the second sensor based on the analyzed speed of the reflected sound waves.

3. The method of claim 1, wherein operating the cooking appliance comprises:
providing, with the controller, an operator notification to adjust a position of the second sensor relative to the fluid in response to determining that the measured fluid level within the food container relative to the second sensor is outside of the selected fluid level range.

4. The method of claim 1, wherein:
the cooking appliance comprises a magnetron configured to emit microwaves within the cooking chamber during a heating operation; and
operating the cooking appliance comprises operating, with the controller, the magnetron to decrease a temperature within the cooking chamber or to prevent emission of microwaves within the cooking chamber in response to determining that the measured fluid level within the food container relative to the second sensor is outside of the selected fluid level range.

5. The method of claim 1, wherein the second sensor is configured as a temperature sensor configured to generate data indicative of a temperature of food contents within the food container.

6. The method of claim 1, further comprising:
receiving, with the controller, an input indicative of a heating operation of the cooking appliance, wherein the selected fluid range is selected with the controller based on the received input.

7. The method of claim 1, further comprising:
prior to receiving the first sensor data from the first sensor, preventing operation of the cooking appliance until the first sensor or the second sensor is wirelessly connected to a remote device.

8. A method of operating a cooking appliance, the cooking appliance comprising a cabinet and a cooking chamber defined within the cabinet, the method comprising:
receiving, with a controller, sensor data from a sensor, the sensor data indicative of fluid within a food container, the food container configured for heating by the cooking appliance;
determining, with the controller, whether the indicated fluid within the food container is outside of a selected fluid level range; and
operating, with the controller, the cooking appliance based on determining whether the indicated fluid within the food container is outside of the selected fluid level range.

9. The method of claim 8, wherein operating the cooking appliance comprises:
providing, with the controller, an operator notification to add fluid to the food container in response to determining that the indicated fluid within the food container is outside of the selected fluid level range.

10. The method of claim 8, wherein determining whether the indicated fluid within the food container is outside of the selected fluid level range comprises:
detecting, with the controller, a presence of the fluid within the food container.

11. The method of claim 8, wherein:
the cooking appliance comprises a magnetron configured to emit microwaves within the cooking chamber during a heating operation; and
operating the cooking appliance comprises operating, with the controller, the magnetron to decrease a temperature within the cooking chamber or to prevent emission of microwaves within the cooking chamber in response to determining that the indicated fluid within the food container is outside of the selected fluid level range.

12. The method of claim 8, wherein determining whether the indicated fluid within the food container is outside of the selected fluid level range comprises:
measuring, with the controller, the fluid level within the food container based on the received sensor data; and
determining, with the controller, whether the measured fluid level within the food container is outside of the selected fluid level range.

13. The method of claim 12, wherein:
the sensor is configured as an ultrasonic sensor configured to emit sound waves into the food container and analyze a speed of reflected sound waves; and
measuring the fluid level comprises measuring, with the controller, the fluid level within the food container based on the analyzed speed of the reflected sound waves.

14. The method of claim 8, further comprising:
receiving, with the controller, an input indicative of a heating operation of the cooking appliance, wherein the selected fluid range is selected with the controller based on the received input.

15. The method of claim 14, wherein receiving the input comprises:
receiving, with the controller, a cooking time input indicative of a length of time, wherein operating the cooking appliance comprises performing the heating operation of the cooking appliance for the length of time.

16. The method of claim 14, wherein receiving the input comprises:
receiving, with the controller, an operator selected temperature input indicative of a temperature, wherein operating the cooking appliance comprises performing the heating operation of the cooking appliance at least until contents within the food container reach the temperature.

17. The method of claim 14, wherein receiving the input comprises:
receiving, with the controller, a power level input indicative of a power level, wherein operating the cooking appliance comprises performing the heating operation of the cooking appliance at the power level.

18. The method of claim 14, wherein:
the sensor corresponds to a first sensor; and
receiving the input comprises receiving, with the controller, an input indicating whether a second sensor is present within the cooking appliance, the second sensor different from the first sensor.

19. The method of claim 18, wherein the second sensor is configured as a temperature sensor configured to generate data indicative of a temperature of food contents within the food container.

20. The method of claim 8, wherein the cooking appliance is configured as a microwave appliance.
